(19) United States
(12) Patent Application Publication
(10) Pub. No.: US 2024/0107489 A1
(43) Pub. Date: Mar. 28, 2024

(54) NETWORK VERIFICATION OF USER EQUIPMENT (UE) LOCATION

(71) Applicant: QUALCOMM Incorporated, San Diego, CA (US)

(72) Inventors: Chiranjib SAHA, San Diego, CA (US); Bharat SHRESTHA, San Diego, CA (US); Umesh PHUYAL, San Diego, CA (US); Alberto RICO ALVARINO, San Diego, CA (US); Xiao Feng WANG, San Diego, CA (US); Harikumar KRISHNAMURTHY, San Diego, CA (US); Peter GAAL, San Diego, CA (US)

(21) Appl. No.: 18/353,418

(22) Filed: Jul. 17, 2023

Related U.S. Application Data
(60) Provisional application No. 63/377,174, filed on Sep. 26, 2022.

(51) Int. Cl. H04W 64/00

(52) U.S. Cl. CPC H04W 64/00

(57) ABSTRACT

Disclosed are techniques for location verification. In an aspect, a radio access network (RAN) node receives a request from a core network node to verify a location of a user equipment (UE), performs a RAN-based positioning procedure with the UE to determine a verified location of the UE, and transmits a response to the core network node, the response including: measurements obtained by the UE during the RAN-based positioning procedure, measurements obtained by the RAN node during the RAN-based positioning procedure, the verified location of the UE, an indication that the location of the UE is verified, or any combination thereof.

### CROSS-REFERENCE TO RELATED APPLICATIONS

The present application for patent claims the benefit of U.S. Provisional Application No. 63/377,174, entitled “NETWORK VERIFICATION OF USER EQUIPMENT (UE) LOCATION,” filed Sep. 26, 2022, assigned to the assignee hereof, and expressly incorporated herein by reference in its entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of location verification performed by a radio access network (RAN) node includes receiving a request from a core network node to verify a location of a user equipment (UE); performing a RAN-based positioning procedure with the UE to determine a verified location of the UE; and transmitting a response to the core network node, the response including: measurements obtained by the UE during the RAN-based positioning procedure, measurements obtained by the RAN node during the RAN-based positioning procedure, the verified location of the UE, an indication that the location of the UE is verified, or any combination thereof.

In an aspect, a method of location verification performed by a core network node includes transmitting a request to a radio access network (RAN) node to verify a location of a user equipment (UE); and receiving a response from the RAN node, the response from the RAN node including measurements obtained by the UE during a RAN-based positioning procedure performed by the RAN node and the UE, measurements obtained by the RAN node during the RAN-based positioning procedure, a RAN node-verified location of the UE, an indication that the location of the UE is verified, or any combination thereof.

In an aspect, a method of location verification performed by a location server includes receiving a request from a core network node to verify a location of a user equipment (UE); performing a location server-based positioning procedure with the UE to determine a verified location of the UE; and transmitting a response to the core network node, the response including a verified location of the UE, an indication that the location of the UE is verified, or any combination thereof.

In an aspect, a radio access network (RAN) node includes a memory; at least one transceiver; and at least one processor communicatively coupled to the memory and the at least one transceiver, the at least one processor configured to: receive, via the at least one transceiver, a request from a core network node to verify a location of a user equipment (UE); perform a RAN-based positioning procedure with the UE to determine a verified location of the UE; and transmit, via the at least one transceiver, a response to the core network node, the response including: measurements obtained by the UE during the RAN-based positioning procedure, measurements obtained by the RAN node during the RAN-based positioning procedure, the verified location of the UE, an indication that the location of the UE is verified, or any combination thereof.

In an aspect, a core network node includes a memory; at least one transceiver; and at least one processor communicatively coupled to the memory and the at least one transceiver, the at least one processor configured to: transmit, via the at least one transceiver, a request to a radio access network (RAN) node to verify a location of a user equipment (UE); and receive, via the at least one transceiver, a response from the RAN node, the response from the RAN node including measurements obtained by the UE during a RAN-based positioning procedure performed by the RAN node and the UE, measurements obtained by the RAN node during the RAN-based positioning procedure, a RAN node-verified location of the UE, an indication that the location of the UE is verified, or any combination thereof.

In an aspect, a location server includes a memory; at least one transceiver; and at least one processor communicatively coupled to the memory and the at least one transceiver, the at least one processor configured to: receive, via the at least one transceiver, a request from a core network node to verify a location of a user equipment (UE); perform a location server-based positioning procedure with the UE to determine a verified location of the UE; and transmit, via the at least one transceiver, a response to the core network node, the response including a verified location of the UE, an indication that the location of the UE is verified, or any combination thereof.

In an aspect, a radio access network (RAN) node includes means for receiving a request from a core network node to verify a location of a user equipment (UE); means for performing a RAN-based positioning procedure with the UE to determine a verified location of the UE; and means for transmitting a response to the core network node, the response including: measurements obtained by the UE during the RAN-based positioning procedure, measurements obtained by the RAN node during the RAN-based positioning procedure, the verified location of the UE, an indication that the location of the UE is verified, or any combination thereof.

In an aspect, a core network node includes means for transmitting a request to a radio access network (RAN) node to verify a location of a user equipment (UE); and means for receiving a response from the RAN node, the response from the RAN node including measurements obtained by the UE during a RAN-based positioning procedure performed by the RAN node and the UE, measurements obtained by the RAN node during the RAN-based positioning procedure, a RAN node-verified location of the UE, an indication that the location of the UE is verified, or any combination thereof.

In an aspect, a location server includes means for receiving a request from a core network node to verify a location of a user equipment (UE); means for performing a location server-based positioning procedure with the UE to determine a verified location of the UE; and means for transmitting a response to the core network node, the response including a verified location of the UE, an indication that the location of the UE is verified, or any combination thereof.

In an aspect, a non-transitory computer-readable medium stores computer-executable instructions that, when executed by a radio access network (RAN) node, cause the RAN to: receive a request from a core network node to verify a location of a user equipment (UE); perform a RAN-based positioning procedure with the UE to determine a verified location of the UE; and transmit a response to the core network node, the response including: measurements obtained by the UE during the RAN-based positioning procedure, measurements obtained by the RAN node during the RAN-based positioning procedure, the verified location of the UE, an indication that the location of the UE is verified, or any combination thereof.

In an aspect, a non-transitory computer-readable medium stores computer-executable instructions that, when executed by a core network node, cause the core network node to: transmit a request to a radio access network (RAN) node to verify a location of a user equipment (UE); and receive a response from the RAN node, the response from the RAN node including measurements obtained by the UE during a RAN-based positioning procedure performed by the RAN node and the UE, measurements obtained by the RAN node during the RAN-based positioning procedure, a RAN node-verified location of the UE, an indication that the location of the UE is verified, or any combination thereof.

In an aspect, a non-transitory computer-readable medium stores computer-executable instructions that, when executed by a location server, cause the location server to: receive a request from a core network node to verify a location of a user equipment (UE); perform a location server-based positioning procedure with the UE to determine a verified location of the UE; and transmit a response to the core network node, the response including a verified location of the UE, an indication that the location of the UE is verified, or any combination thereof.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates examples of various positioning methods supported in New Radio (NR), according to aspects of the disclosure.

FIG. 5 illustrates example Long-Term Evolution (LTE) positioning protocol (LPP) reference sources for positioning.

FIG. 6 illustrates a procedure for the general network positioning for location services (LCS) clients external to the public land mobile network (PLMN) for the regulatory location service for non-roaming scenarios, according to aspects of the disclosure.

FIG. 7 is a diagram illustrating UE provided location verification based on obtained information, according to aspects of the disclosure.

FIG. 8 illustrates an example procedure for an access and mobility management function (AMF)-verified UE location, according to aspects of the disclosure.

FIG. 9 illustrates an example procedure for a location management function (LMF)-verified UE location, according to aspects of the disclosure.

FIG. 10 illustrates further details of an example procedure for an LMF-verified UE location, according to aspects of the disclosure.

FIG. 11 illustrates an example procedure for a radio access network (RAN)-verified UE location, according to aspects of the disclosure.

FIG. 12 is a diagram illustrating an example of a space vehicle generating multiple transmit beams over multiple geographic regions.

FIGS. 13 to 15 illustrate example methods of location verification, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to wireless positioning. Some aspects more specifically relate to network verification of user equipment (UE) location. In some examples, location information reported by a UE may be verified by an access and mobility management function (AMF), a location management function (LMF), or a radio access network (RAN) node by performing a different positioning method from the UE, such as a radio access technology (RAT)-based positioning procedure. In some examples, the AMF may maintain a list of UEs within its context with verified locations. A UE may have a validity timer associated with it that may be triggered upon a verification of its location. Another verification process may be triggered upon expiration of the UE timer, UE tracking area change, UE location change above a threshold, and/or UE registration area update.

Particular aspects of the subject matter described in this disclosure can be implemented to realize one or more of the following potential advantages. In some examples, by performing a different positioning method than the positioning method used by the UE to report its location, the described techniques can be used to enable network verification of a UE's location.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof.

Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions.

A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

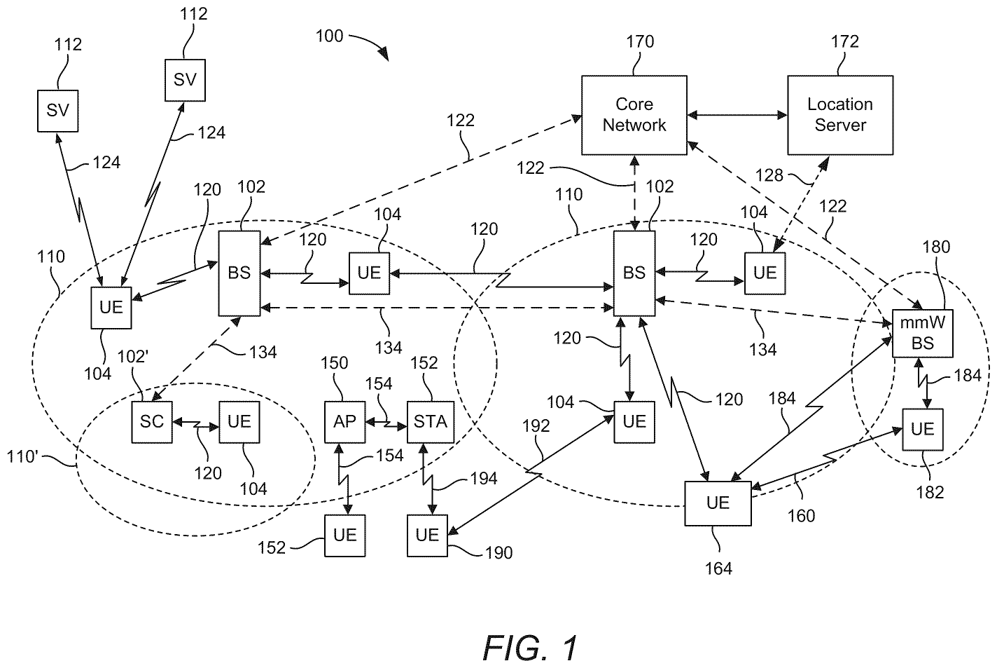

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

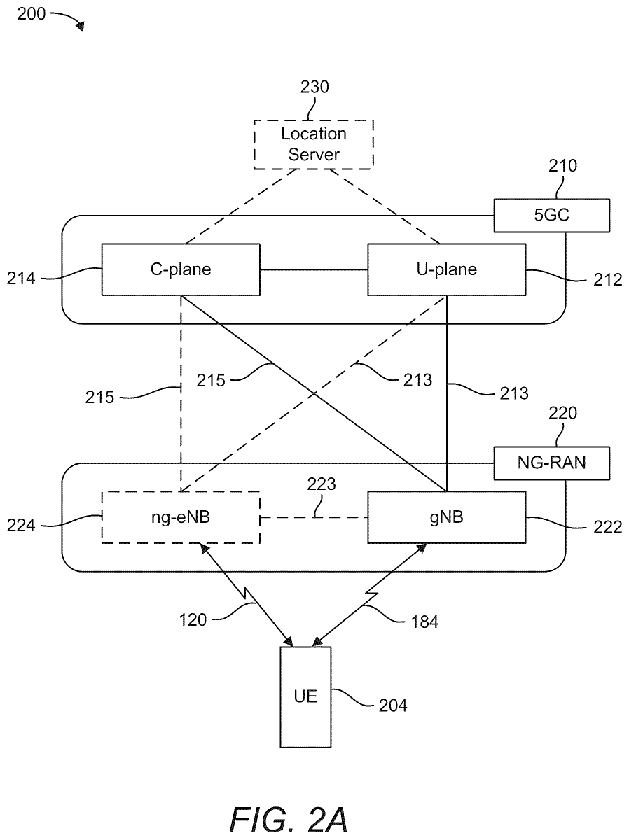

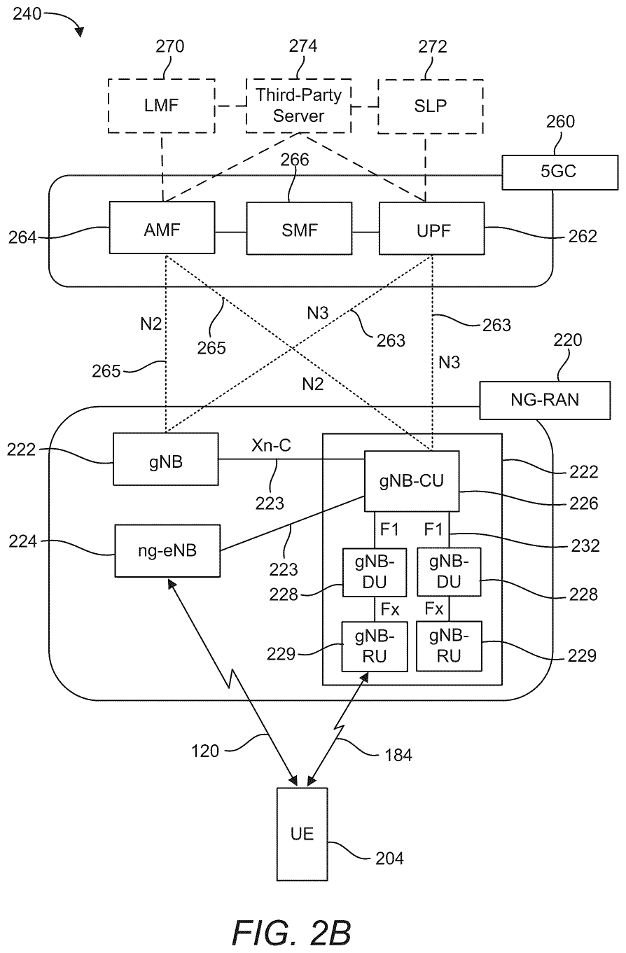

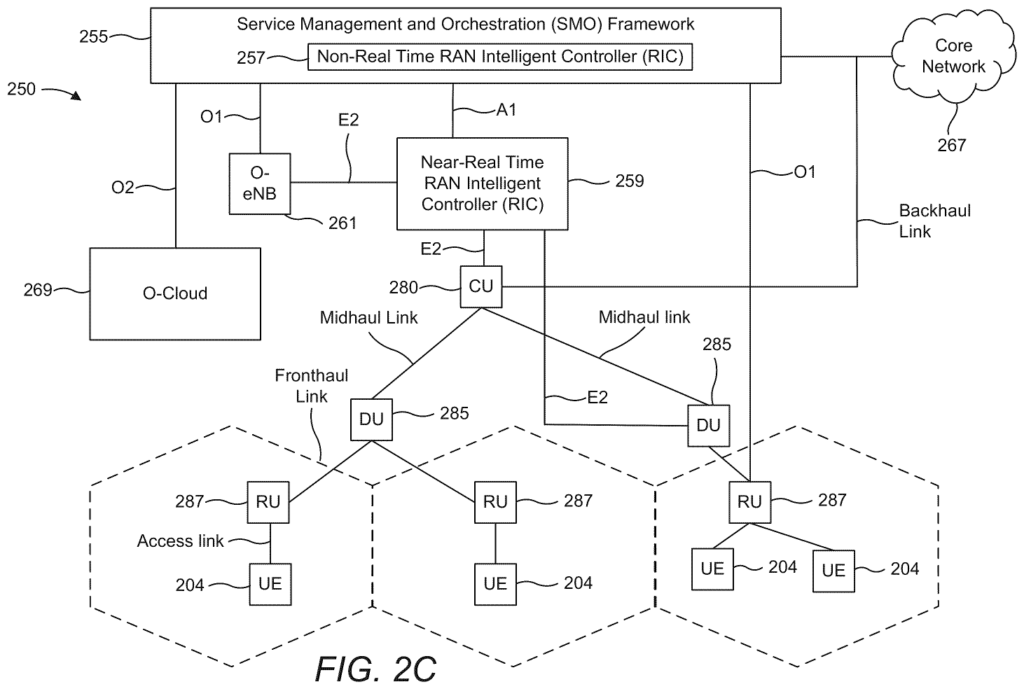

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, access point (AP), a transmit receive point (TRP), or a cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more distributed units (DUs) 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUs 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 280 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via 01) or via creation of RAN management policies (such as A1 policies).

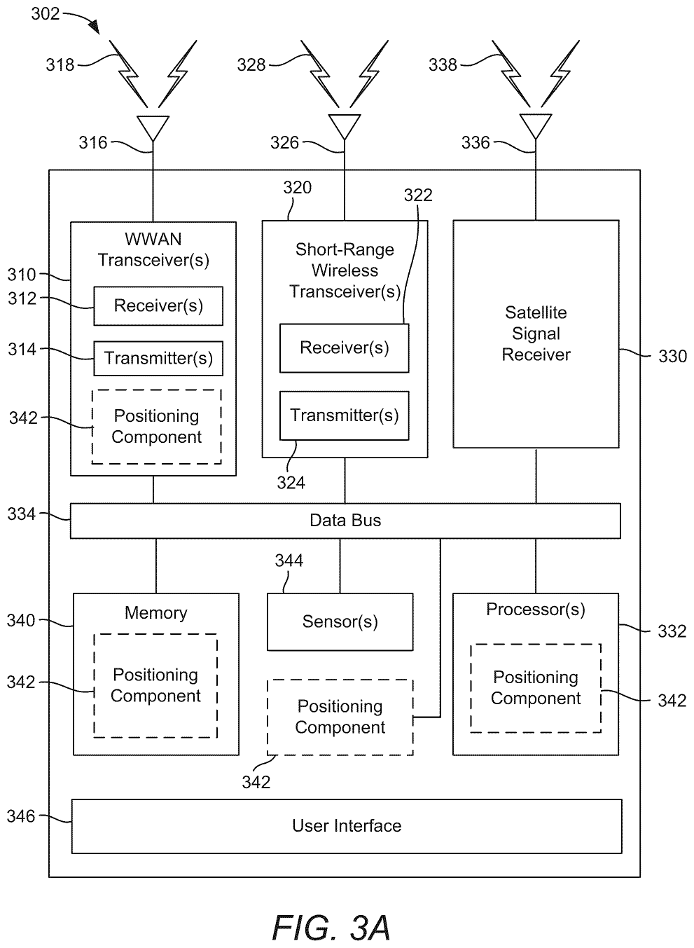

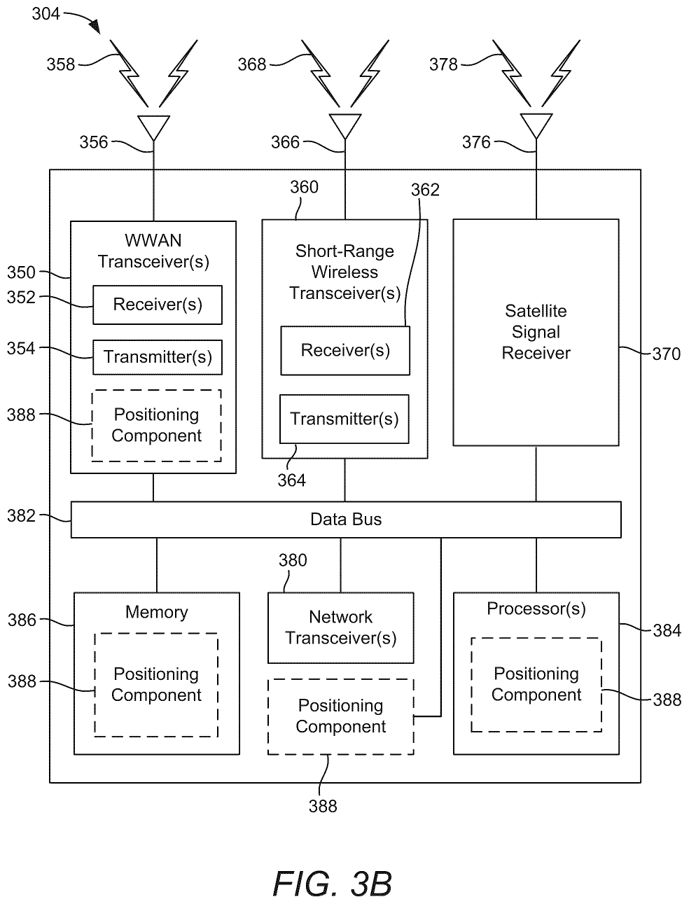

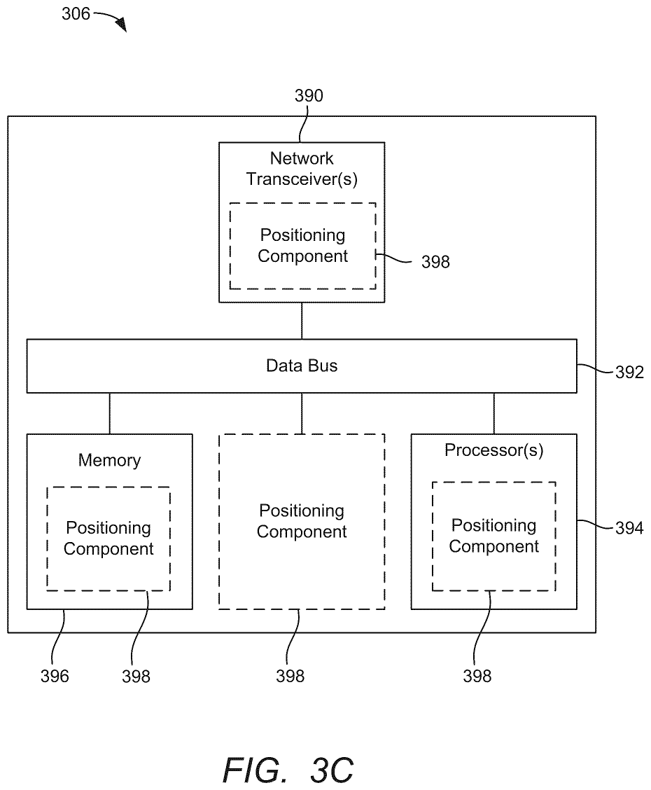

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 342, 388, and 398, respectively. The positioning component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning component 342, 388, and 398 may be external to the processors 332, 384, and 394 (e.g., part of a modem processing system, integrated with another processing system, etc.). Alternatively, the positioning component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning component 342, which may be, for example, part of the one or more WWAN transceivers 310, the memory 340, the one or more processors 332, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the downlink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

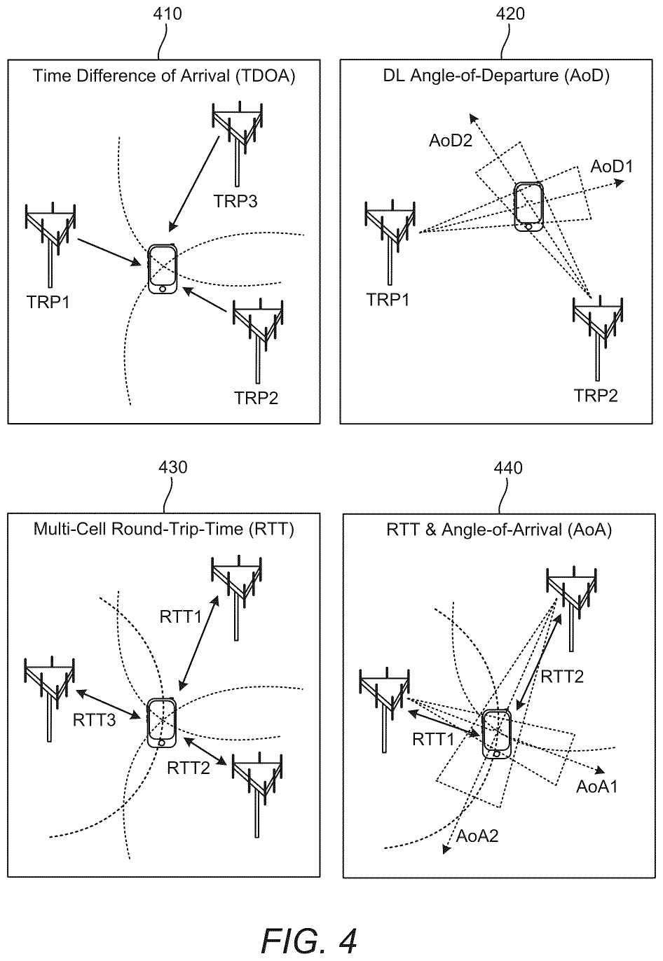

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. FIG. 4 illustrates examples of various positioning methods, according to aspects of the disclosure. In an OTDOA or DL-TDOA positioning procedure, illustrated by scenario 410, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, illustrated by scenario 420, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, illustrated by scenario 430, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 440.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

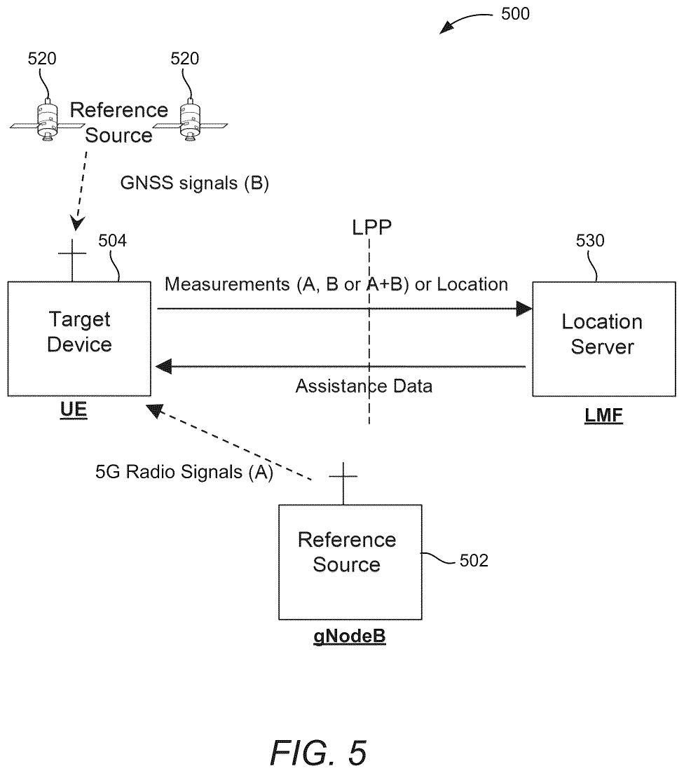

In LTE and, at least in some cases, NR, positioning measurements are reported through higher layer signaling, specifically, LTE positioning protocol (LPP) and/or RRC. LPP is used point-to-point between a location server (e.g., location server 230, LMF 270, SLP 272) and a UE (e.g., any of the UEs described herein) in order to position the UE using location related measurements obtained from one or more reference sources. FIG. 5 is a diagram 500 illustrating example LPP reference sources for positioning. In the example of FIG. 5, a target device, specifically a UE 504 (e.g., any of the UEs described herein), is engaged in an LPP session with a location server 530 (labeled as an “LMF” in the specific example of FIG. 5). The UE 504 is also receiving/measuring wireless positioning signals from a first reference source, specifically one or more base stations 502 (which may correspond to any of the base stations described herein, and which is labelled as an “gNode B” in the specific example of FIG. 5), and a second reference source, specifically one or more SPS satellites 520 (which may correspond to SVs 112 in FIG. 1).

An LPP session is used between a location server 530 and a UE 504 in order to obtain location-related measurements or a location estimate or to transfer assistance data. A single LPP session is used to support a single location request (e.g., for a single mobile-terminated location request (MT-LR), mobile originated location request (MO-LR), or network induced location request (NI-LR)). Multiple LPP sessions can be used between the same endpoints to support multiple different location requests. Each LPP session comprises one or more LPP transactions, with each LPP transaction performing a single operation (e.g., capability exchange, assistance data transfer, location information transfer). LPP transactions are referred to as LPP procedures. The instigator of an LPP session instigates the first LPP transaction, but subsequent transactions may be instigated by either endpoint. LPP transactions within a session may occur serially or in parallel. LPP transactions are indicated at the LPP protocol level with a transaction identifier in order to associate messages with one another (e.g., request and response). Messages within a transaction are linked by a common transaction identifier.

LPP positioning methods and associated signaling content are defined in the 3GPP LPP standard (3GPP Technical Specification (TS) 36.355, which is publicly available and incorporated by reference herein in its entirety). LPP signaling can be used to request and report measurements related to the following positioning methods: OTDOA, DL-TDOA, assisted global navigation satellite system (A-GNSS), LTE E-CID, NR E-CID, sensor, terrestrial beacon system (TBS), WLAN, Bluetooth, DL-AoD, UL-AoA, and multi-RTT. Currently, LPP measurement reports may contain the following measurements: (1) one or more ToAs, TDOA, reference signal time difference (RSTD), or Rx-Tx time difference measurements, (2) one or more AoA and/or AoD measurements (currently only for a base station to report UL-AoA and DL-AoD to the location server 530), (3) one or more multipath measurements (per-path ToA, RSRP, AoA/AoD), (4) one or more motion states (e.g., walking, driving, etc.) and trajectories (currently only for the UE 504), and (5) one or more report quality indications. In the present disclosure, positioning measurements, such as the example measurements just listed, and regardless of the positioning technology, may be referred to collectively as positioning state information (PSI).

The UE 504 and/or the location server 530 may derive location information from one or more reference sources, illustrated in the example of FIG. 5 as SPS satellite(s) 520 and the base station(s) 502. Each reference source can be used to calculate an independent estimate of the location of the UE 504 using associated positioning techniques. In the example of FIG. 5, the UE 504 is measuring characteristics (e.g., ToA, RSRP, RSTD, etc.) of positioning signals received from the base station(s) 502 to calculate, or to assist the location server 530 to calculate, an estimate of the location of the UE 504 using one or more RAT-dependent (also referred to as “RAN-based”) positioning methods (e.g., multi-RTT, OTDOA, DL-TDOA, DL-AoD, E-CID, etc., as described above with reference to FIG. 4). Similarly, the UE 504 is measuring characteristics (e.g., ToA) of GNSS signals received from the SPS satellites 520 to triangulate its location in two or three dimensions, depending on the number of SPS satellites 520 measured. In some cases, the UE 504 or the location server 530 may combine the location solutions derived from each of the different positioning techniques to improve the accuracy of the final location estimate.

As noted above, the UE 504 uses LPP to report location related measurements obtained from different of reference sources (e.g., base stations 502, Bluetooth beacons, SPS satellites 520, WLAN access points, motion sensors, etc.). As an example, for GNSS-based positioning, the UE 504 uses the LPP information element (IE) “A-GNSS-ProvideLocationInformation”to provide location measurements (e.g., pseudo ranges, location estimate, velocity, etc.) to the location server 530, together with time information. It may also be used to provide a GNSS positioning-specific error reason. The “A-GNSS-ProvideLocationInformation” IE includes IEs such as “GNSS-SignalMeasurementInformation,” “GNSS-LocationInformation,” “GNSS-MeasurementList,” and “GNSS-Error.” The UE 504 includes the “GNSS-LocationInformation” IE when it provides location and optionally velocity information derived using GNSS or hybrid GNSS and other measurements to the location server 530.

The UE 504 uses the “GNSS-SignalMeasurementInformation” IE to provide GNSS signal measurement information to the location server 530 and the GNSS network time association if requested by the location server 530. This information includes the measurements of code phase, Doppler, C/No, and optionally accumulated carrier phase, also referred to as accumulated delta range (ADR), which enable the UE assisted GNSS method where location is computed in the location server 530. The UE 504 uses the “GNSS-MeasurementList” IE to provide measurements of code phase, Doppler, C/No, and optionally accumulated carrier phase (or ADR).

As another example, for motion sensor-based positioning, the currently supported positioning methods use a barometric pressure sensor and a motion sensor, as described in 3GPP TS 36.305 (which is publicly available and incorporated by reference herein in its entirety). The UE 504 uses the LPP IE “Sensor-ProvideLocationInformation” to provide location information for sensor-based methods to the location server 530. It may also be used to provide a sensor-specific error reason. The UE 504 uses the “Sensor-MeasurementInformation” IE to provide sensor measurements (e.g., barometric readings) to the location server 530. The UE 504 uses the “Sensor-MotionInformation” to provide movement information to the location server 530. The movement information may comprise an ordered series of points. This information may be obtained by the UE 504 using one or more motion sensors (e.g., accelerometers, barometers, magnetometers, etc.).

As yet another example, for Bluetooth-based positioning, the UE 504 uses the “BT-ProvideLocationInformation” IE to provide measurements of one or more Bluetooth beacons to the location server 530. This IE may also be used to provide Bluetooth positioning specific error reason.

A network operator may be mandated to crosscheck the UE location reported by a UE in order to fulfil regulatory requirements regarding a network-verified UE location (e.g., lawful intercept, emergency calls, public warning systems, etc.). That is, the network operator should be able to check a UE's reported location information by, for example, estimating the UE's location at the network side, and to specify whether a mechanism is needed to fulfil the regulatory requirements. Currently, to determine a network-verified UE location, an NTN-capable UE may report its global navigation satellite system (GNSS) location (as NTN-capable UEs are required to have GNSS), and the network (e.g., a location server) verifies or refines the UE's GNSS report through NTN positioning techniques.

In greater detail, the 5G NR system is being enhanced to support the service requirements of 5GC with satellite access. Currently, when a UE is using NR satellite access, in order to ensure that regulatory requirements are met, the network will verify whether the public land mobile network (PLMN) selected by the UE is allowed to operate in the country of the UE location based on the UE location information. Additionally, the broadcast tracking area identifier(s) (TAI(s)) and the TAI where the UE is geographically located, if known, should be provided as part of user location information (ULI) by the NG-RAN to the AMF. Using UE-generated location information (e.g., GNSS) to determine the TAI where the UE is geographically located can be accurate but may be unreliable.

When the UE accesses 5G via satellite access, some services with regulatory requirements, such as emergency call services and lawful interception, require trusted/reliable methods to determine with sufficient accuracy the UE location. Any method that relies solely on UE-generated location information may not be reliable unless the information provided by the UE can be verified by the network. However, there are still various issues that need to be resolved. For example, the kind of location information that can represent the UE location that would meet the required accuracy in NR satellite access has not been determined. As another example, in RAN collaboration scenarios, for the reliability of the location verification by the network for regulated services, it is not yet determined how the 5GC LCS can ensure that network verification of UE location is performed with a reliable method, that does not rely solely on UE-generated location information, and that the result of such network verification of the UE location meets aforementioned requirements. As another example, again for RAN collaboration scenarios, it has not been determined whether existing core network verification mechanisms need enhancement and conditions. As yet another example, it has not been determined how to further enhance the LCS to verify location services related requirements.

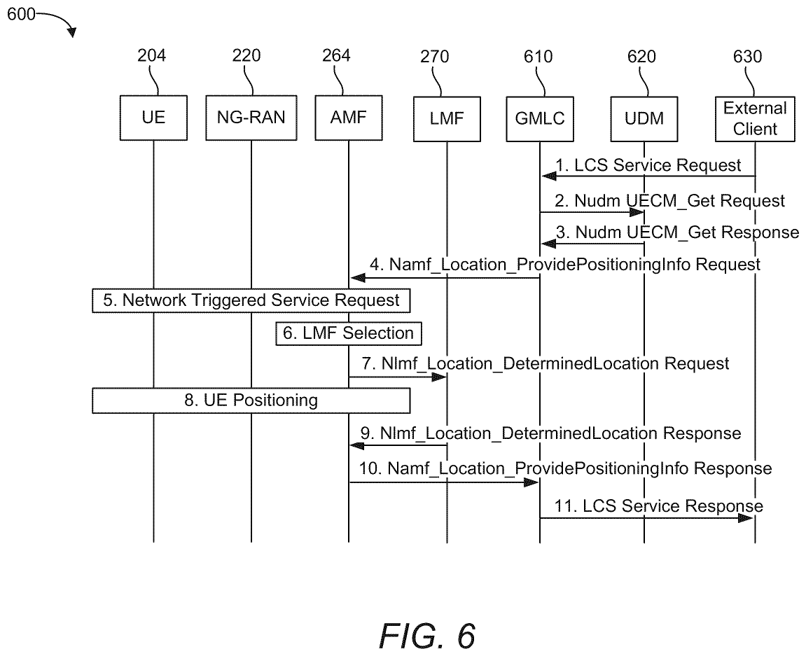

FIG. 6 illustrates a procedure 600 for the general network positioning for LCS clients external to the PLMN for the regulatory location service for non-roaming scenarios, according to aspects of the disclosure. In this scenario, it is assumed that the target UE 204 is identified using a subscription permanent identifier (SUPI), generic public subscription identifier (GPSI), a permanent equipment identifier (PEI), or the like. The procedure 600 is applicable to a request from an LCS client (external location services client 630) for a current location of the target UE 204, and it is assumed that the LCS client is authorized to use the location service and no privacy verification is required. The procedure 600 is defined in 3GPP TS 23.273, which is publicly available and incorporated by reference herein in its entirety.

At stage 1, the external location services client 630 sends a request to the gateway mobile location center (GMLC) 610 for a location for the target UE 204 identified by a GPSI or an SUPI. The request may include the required QoS and supported geographical area description (GAD) shapes. If location is required for more than one UE, the stages following below may be repeated, and in that case, the GMLC 610 verifies whether the number of target UEs 204 in the LCS request is equal to or less than the Maximum Target UE Number of the LCS client. If the Maximum Target UE Number is exceeded, the GMLC 610 rejects the LCS request, stages 2-10 are skipped, and then the GMLC 610 responds to the client with a proper error cause in stage 11.

At stage 2, the GMLC 610 invokes a “Nudm_UECM_Get” service operation towards the home unified data management (UDM) 620 of the target UE 204 to be located with the GPSI or SUPI of this UE 204.

At stage 3, the UDM 620 returns the network addresses of the current serving AMF 264. Note that for backward compatibility, the GMLC 610 can use a “Nudm_SDM_Get” service operation to retrieve the SUPI of the target UE 204 from an earlier-generation UDM 620.

At stage 4, the GMLC 610 invokes the “Namf_Location_ProvidePositioningInfo” service operation towards the AMF 264 to request the current location of the target UE 204. The service operation includes the SUPI and client type and may include the required QoS and supported GAD shapes.

At stage 5, if the UE 204 is in CM IDLE state, the AMF 264 initiates a network triggered Service Request procedure to establish a signaling connection with the UE 204.

At stage 6, the AMF 264 selects an LMF 270 based on the available information or based on AMF 264 local configuration. The LMF 270 selection takes the 5G access network currently serving the UE 204 into account. The selection may use a network repository function (NRF) query. Note that the LMF 270 is the network entity in the 5GC supporting at least the following functionality: (1) supports location determination for a UE 204, (2) obtains downlink location measurements or a location estimate from the UE 204, (3) obtains uplink location measurements from the NG-RAN 220, (4) obtains non-UE associated assistance data from the NG-RAN 220, and (5) provides broadcast assistance data to UEs and forwards associated ciphering keys to an AMF 264.

At stage 7, the AMF 264 invokes the “Nlmf_Location_DetermineLocation” service operation towards the LMF 270 to request the current location of the UE 204. The service operation includes an LCS Correlation identifier, the serving cell identity of the primary cell in the master RAN node and the primary cell in the secondary RAN node when available based on dual connectivity scenarios, and the client type, and may include an indication if the UE 204 supports LPP, the required QoS, UE positioning capabilities if available, and supported GAD shapes. In some cases, the service operation includes the AMF identity.

At stage 8, the LMF 270 performs one or more LPP-based positioning procedures with the UE 204, such as described above with reference to FIG. 4. During this stage the LMF 270 may use the “Namf_Communication_N1N2MessageTransfer” service operation to request the transfer of a positioning related N1 message to the UE 204 or the transfer of a network positioning message to the serving NG-RAN node (e.g., gNB or ng-eNB) for the UE 204. The LMF 270 determines a geographical location and optionally a location in local coordinates.

At stage 9, the LMF 270 returns the “Nlmf_Location_DetermineLocation” response towards the AMF 264 to return the current location of the UE 204 and the UE positioning capabilities if the UE positioning capabilities are received in stage 8, including an indication that the capabilities are non-variable and not received from the AMF 264 in stage 7. The service operation includes the LCS correlation identifier, the location estimate, its age and accuracy, and may include information about the positioning method and the timestamp of the location estimate.

At stage 10, the AMF 264 returns the “Namf_Location_ProvidePositioningInfo” response towards the GMLC 610 to return the current location of the UE 204. The service operation includes the location estimate, its age and accuracy, and may include information about the positioning method and the timestamp of the location estimate. The AMF 264 stores the UE positioning capabilities in UE context when received from LMF 270.

At stage 11, the GMLC 610 sends the location service response to the external location services client 630.

One of the services offered by the LMF 270 to other network functions (NFs) is the “Nlmf_Location” service. The “Nlmf_Location” service enables an NF to request a location determination (current geodetic and optionally local and/or civic location) for a target UE, such as at stage 7 of FIG. 6, or to request periodic or triggered location for a target UE. The service operations defined for the “Nlmf_Location” service are as follows: (1) “DetermineLocation,” which provides UE location information to the consumer NF, (2) “EventNotify,” which notifies the consumer NF of an event for periodic or triggered location for a target UE, (3) “CancelLocation,” which enables a consumer NF to cancel an ongoing periodic or triggered location for a target UE, and (4) “LocationContextTransfer,” which enables a consumer NF to transfer location context information for periodic or triggered location of a target UE to a new LMF.

A “DetermineLocation” includes input data such as the correlation ID, AMF ID, location QoS, and usage (which indicates the usage made of the location measurement). There is a satellite-specific input of “ueCountryDetlnd.” When this Boolean input parameter is present, it contains an indication of determining the country or international area indication where the UE is located. The enumeration of the usage input parameter represents the type of usage made of the location measurement from the UE. It may indicate that the result was (1) not successful, (2) successful but not used, (3) successful and used to verify the location estimate, (4) successful and used to generate the location estimate, (5) or successful method not determined.

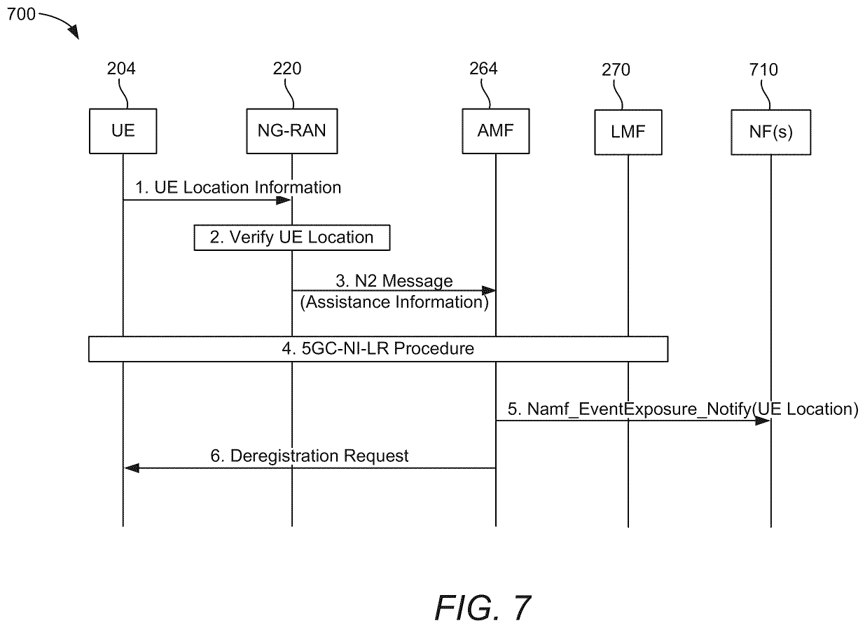

FIG. 7 is a diagram 700 illustrating UE provided location verification based on obtained information, according to aspects of the disclosure.

At stage 1, a UE 204 sends UE location information (e.g., GNSS information) to the NG-RAN 220 over the NR-Uu interface via satellite access.

At stage 2, if the NG-RAN 220 can verify the UE location, it verifies the reported UE location. Whether the NG-RAN 220 can verify the UE location and how to verify the UE location depends on the conclusion of the network-verified UE location objective.

At stage 3, if stage 2 is performed, the NG-RAN 220 sends an N2 message including the assistance information to the AMF 264.

At stage 4, if the assistance information provided by NG-RAN 220 indicates that the UE location is not-reliable, and the country of the UE-reported location is the same as the country of the network-verified UE location, and there are one or more NFs 710 subscribed to the UE location event report, the AMF 264 triggers a 5GC network-initiated location request (NI-LR) procedure to obtain the UE location.

At stage 5, if stage 4 is performed, the AMF 264 notifies the UE location to the NF(s) 710.

At stage 6, if the assistance information provided by the NG-RAN 220 indicates that the UE location is not-reliable and the country of the UE-reported location is different from the country of the network-verified UE location, the AMF 264 deregisters the UE 204.

The impacts on the services, entities, and interfaces caused by the procedure illustrated in FIG. 7 include the following. For the AMF 264, the AMF 264 receives assistance information from the NG-RAN 220 and behaves accordingly. For the NG-RAN 220, the NG-RAN 220 verifies the UE location reported by the UE 204 and provides assistance information to the AMF 264. Note that whether and what assistance information can be provided by the NG-RAN 220 depends on the conclusion of the network-verified UE location objective.

The present disclosure provides techniques for network verification of UE location. Different options regarding the signal flow for location verification service are proposed. Based on which network node performs verification, there could be three alternatives: (1) the AMF verifies the UE location, (2) the LMF verifies the UE location, or (3) the RAN node verifies the UE location.

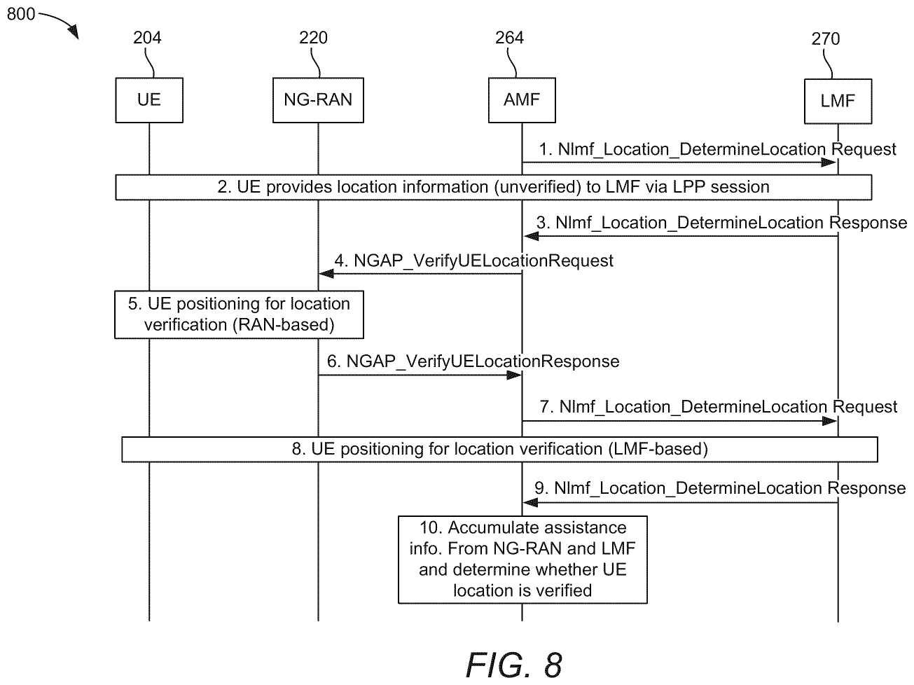

FIG. 8 illustrates an example procedure 800 for an AMF-verified UE location, according to aspects of the disclosure. The procedure 800 illustrated in FIG. 8 may be performed when an AMF 264 receives a request for the location of a UE 204, such as at stage 4 of FIG. 6.

At stage 1, the AMF 264 invokes the “Nlmf_Location_DetermineLocation” service operation towards the LMF 270 to request the current location of the UE 204, as at stage 7 of FIG. 6.

At stage 2, the LMF 270 obtains a location of the UE 204 via LPP signaling. The location may be obtained using a RAT-dependent (RAN-based) positioning method, such as one of the positioning methods described above with reference to FIG. 4, or a RAT-independent positioning method, such as a GNSS-based positioning method.

At stage 3, the LMF 270 returns the “Nlmf_Location_DetermineLocation” response towards the AMF 264, as at stage 9 of FIG. 6, to return the current location of the UE 204. In addition, an additional flag may be included in the response to indicate that the UE location is “unverified,” or alternately, the AMF 264 may treat the location as “unverified” if the response indicates some specific positioning method (e.g., GNSS or any other non-RAT-dependent method).

At stage 4, the AMF 264 sends a request to the NG-RAN 220 serving the UE to verify the UE location, denoted, for example, as “NGAP_VerifyUELocationRequest.” Note that Next Generation Application Protocol (NGAP) is the protocol used between an AMF 264 and an NG-RAN 220.

At stage 5, the NG-RAN 220 (e.g., a satellite in the NG-RAN 220) performs a RAT-dependent positioning procedure with the UE 204. The RAT-dependent positioning procedure may employ a positioning method that uses a single NG-RAN node, such as RTT, RSRP, AoA, AoD, etc.

At stage 6, the NG-RAN 220 responds to the AMF 264 with a verified location of the UE 204. The response may be denoted, for example, “NGAP_VerifyUELocationResponse.” The response may include assistance information, such as the type of positioning method and/or the relevant measurements (e.g., UE Rx-Tx time difference, gNB Rx-Tx time difference, RSRP, AoA AoD, etc.).

At stage 7, the AMF 264 may request the LMF 270 to perform location verification by invoking another “Nlmf_Location_DetermineLocation” service operation towards the LMF 270, as at stage 7 of FIG. 6. The request may indicate that the request is for UE location verification.

At stage 8, the LMF 270 initiates an LPP session with the UE 204 for a RAT-dependent positioning procedure, as at stage 8 of FIG. 6. The positioning procedure may involve multiple NG-RAN nodes, if available, and therefore, may be different from the LPP positioning procedure performed at stage 5 (e.g., multi-RTT, DL-TDOA, UL-TDOA, etc.).

At stage 9, the LMF 270 responds to the AMF 264 with the UE location, as at stage 9 of FIG. 6. The response may include a flag indicating that the location is “trusted” or “verified.” Alternatively, the AMF 264 may assume that this location information is trustable/verified based on the positioning method (e.g., a RAT-dependent method). The response may include assistance information, such as the type of positioning method and/or the relevant measurements (e.g., UE Rx-Tx time difference(s), gNB Rx-Tx time difference(s), RSTD(s), RSRP(s), etc.).

At stage 10, based on the responses from the NG-RAN 220 (stage 6) and the LMF 270 (stage 9), the AMF 264 determines whether the UE location is verified. If it is, the AMF 264 responds to the requesting entity with the location of the UE 204, as at stage 10 of FIG. 6.

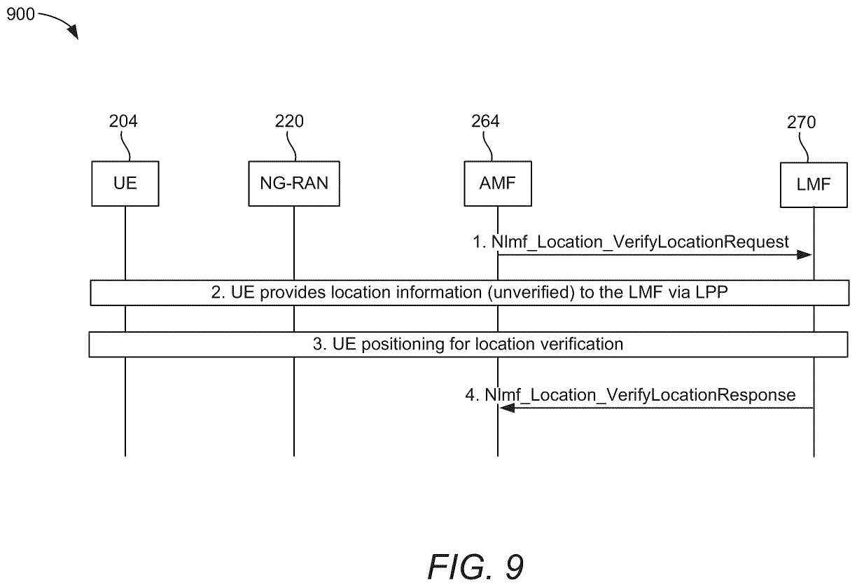

FIG. 9 illustrates an example procedure 900 for an LMF-verified UE location, according to aspects of the disclosure.

At stage 1, the LMF 270 receives a request from an AMF 264 for a verified UE location. The request may include the UE location to be verified or a flag indicating that the LMF 270 should return a verified UE location. The request may be denoted, for example, as “Nlmf_Location_VerifyLocationRequest” or the like.

At stage 2, the LMF 270 initiates an LPP session with the UE 204 to obtain the UE's 204 location. In response, the UE 204 provides its location, which may be based on a non-RAT-dependent positioning method, and therefore, is not considered to be verified. In some cases, even if the location is based on a RAT-dependent positioning method, it may be treated as unverified.

At stage 3, the LMF 270 initiates a subsequent LPP session with the UE 204 to obtain the UE's 204 verified location. This positioning procedure should use a RAT-dependent positioning procedure and may involve one or more NG-RAN nodes (terrestrial and/or satellite-based). The positioning procedure may be UE-assisted (i.e., the UE 204 provides positioning measurements and the LMF 270 determines the UE's 204 location from the measurement and other information, such as the locations of the measured base stations) or UE-based (i.e., the UE provides its determined location based on assistance data received from the LMF 270 and/or involved base stations).

At stage 4, if the request at stage 1 included the UE location, the LMF 270 responds to the AMF 264 indicating whether the UE location has been verified. If the request at stage 1 was for a verified location, the LMF 270 provides the verified UE location. The response may be denoted, for example, “Nlmf_Location_VerifyLocationResponse” or the like.

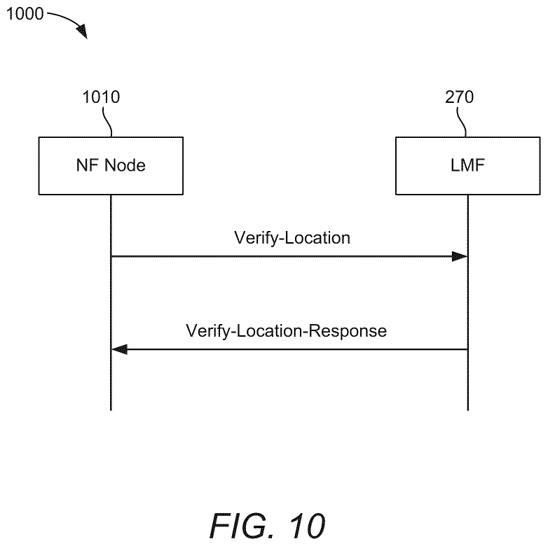

FIG. 10 illustrates further details of an example procedure 1000 for an LMF-verified UE location, according to aspects of the disclosure. In some cases, any network function (NF) node 1010 may request the LMF 270 for a verified location of a UE 204. In the case that the NF node 1010 is an AMF 264, the procedure 1000 may correspond to stages 1 and 4 of FIG. 9.

To support such a procedure, a new LCS service can be added, denoted, for example, “Verify-Location.” The Verify-Location request may include (but is not limited to) the following fields: (1) UE ID (e.g., SUPI, PEI, GPSI), (2) a region indication (e.g., a country ID or state ID) where the UE is expected to be located, (3) one or more accuracy parameters (e.g., up to five kilometers horizontal distance accuracy, ignore height estimation error, etc.), and/or (4) a timer within which the LMF 270 should provide a response (failure will result in a timeout). If the request is simply to verify an obtained UE location, the request may further include the UE location to be verified.

The response to the Verify-Location request may be denoted, for example, “Verify-Location-Response.” The following fields may be present in the response message: (1) LocationVerified (having a Boolean value of “0” or “1”), (2) QoS, (3) error cause(s), (4) which positioning method(s) were used to verify the UE location (e.g., GNSS plus DL-TDOA), (5) the time taken to verify the location, and/or (6) a confidence value/probability indication. The error causes that may be indicated in the response may include (1) denied positioning, (2) unsupported by UE, (3) positioning failed, and/or (4) request timeout. If the request was for the actual UE location, the response may further include the verified UE location.

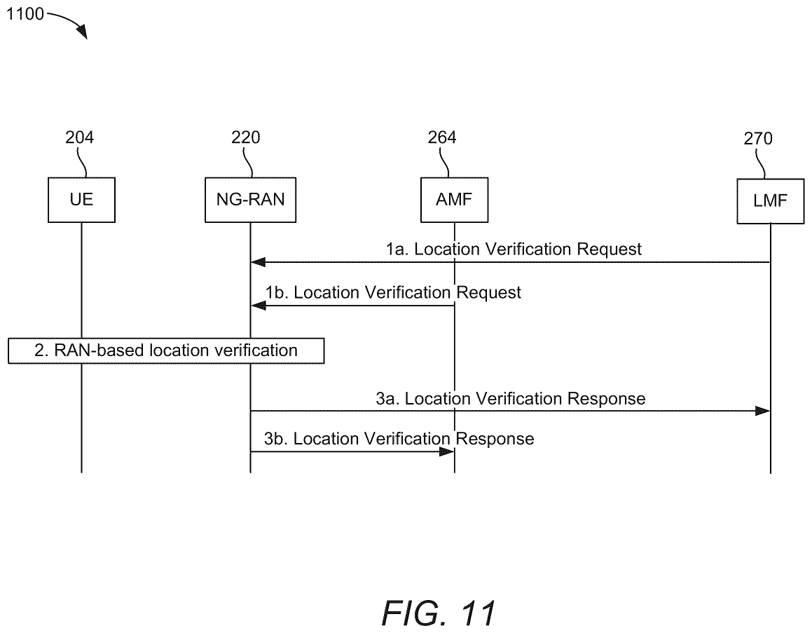

FIG. 11 illustrates an example procedure 1100 for a RAN-verified UE location, according to aspects of the disclosure. In an aspect, before the procedure 1100 is triggered, the NG-RAN node may indicate a capability to verify the location of a UE 204 to other core network nodes (e.g., AMF 264, LMF 270, etc.). For example, where the NG-RAN node is a satellite, it may have a steerable spare beam that could be used for AoA estimation that could meet the target verification requirement. Without a steerable spare beam, a satellite NG-RAN node may not be able to locate the UE with sufficient accuracy to verify the UE location.

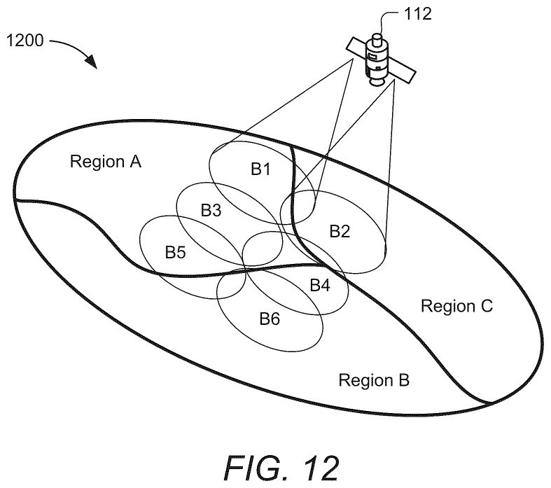

More specifically, there may be some ambiguity with respect to the country or state within which a UE is located when the NG-RAN node is a satellite or other space vehicle. FIG. 12 is a diagram 1200 illustrating an example of a space vehicle 112 generating multiple transmit beams (labeled “B1,” “B2,” “B3,” “B4,” “B5,” and “B6”) over multiple geographic regions (labeled “Region A,” “Region B,” and “Region C”), which may be countries, states, or other types of regions. As shown in FIG. 12, satellites or aerial vehicles, such as space vehicle 112, typically generate several beams (e.g., B1 to B6) over a given geographic area (e.g., Regions A, B, and C), and the footprints of these beams are typically elliptical in shape. The beam footprint may move over the Earth with the movement of the satellite or the aerial vehicle on its orbit. Alternatively, the beam footprint may be Earth-fixed. In that case, beam pointing mechanisms (mechanical or electronic steering) may be used to compensate for the motion of the satellite or the aerial vehicle.

If the space vehicle 112 in FIG. 12 has a steerable spare beam, it may be able to use that beam to estimate the AoA and/or AoD associated with a UE with sufficient accuracy to at least determine in which region (e.g., Regions A, B, and C) the UE is located. For example, a UE serviced by beam B4, for example, has an almost equal chance of being in Region A or Region B. However, if the space vehicle 112 has a steerable spare beam, it can steer that beam to Region A or Region B to determine in which region the UE is located.

Referring back to FIG. 11, the procedure 1100 is a modification of stages 4-6 of the procedure 800 of FIG. 8, in which the location verification decision is performed by the NG-RAN node. At stage 1, the NG-RAN node (e.g., a terrestrial or satellite-based gNB or ng-eNB) receives a location verification request from an LMF 270 (stage 1a) or an AMF 264 (stage 1b). In this case, the request from the core network node should include the UE location.

At stage 2, the NG-RAN node engages in a positioning procedure with the UE 204 to obtain the UE's location. This stage includes two steps. The first is acquiring the unverified UE location at the NG-RAN node. This can be done by either (1) the ULI being in the verification request coming from a core network node, or (2) the ULI coming from the UE 204 over RRC signaling. The second step is the verification of this location, for which the NG-RAN node engages in a positioning procedure with the UE 204 to obtain the UE's 204 location. The positioning procedure may be a RAT-dependent positioning procedure that involves only the one NG-RAN node, such as RTT, RSRP, AoA, AoD, etc. As such, the NG-RAN node collects measurements from the UE 204 (e.g., DL-TDOA, UE Rx-Tx time difference, DL-RSRP, etc.) and performs some uplink measurements of reference signals (e.g., SRS) transmitted by the UE 204 (e.g., gNB Rx-Tx time difference, AoA, UL-TDOA, etc.). This positioning procedure may be UE-assisted. However, UE-based positioning could still be used when this operation is performed inside a cellular modem, as it is difficult to tamper with this operation as the modems has to satisfy a set of accuracy requirements. This is different from the case where the UE 204 is simply reporting its location obtained from a source outside the modem (e.g., GNSS).

At stage 3, if the request at stage 1 included the UE location, the NG-RAN node responds to the LMF 270 (stage 3a) or the AMF 264 (stage 3b) with an indication of whether the UE location has been verified. If the request at stage 1 was for a verified location, the NG-RAN node provides the verified UE location.

Regarding the validity of the verification, an AMF 264 may maintain a list of UEs 204 and whether their locations have been verified, as long as the UEs 204 are within the context of the AMF 264. Once a UE's 204 location is verified, a validity timer is triggered. The AMF 264 may trigger a subsequent verification process if (1) the validity timer expires. (2) the UE 204 performs a tracking area update or a registration area update, (3) if the UE 204 reports a new location and the UE's 204 location has changed significantly (e.g., greater than some threshold, such as the UE 204 has changed its country).

In an aspect, if the UE's 204 location has not changed significantly (e.g., less than a threshold) between multiple transitions between the RRC IDLE or the RRC INACTIVE and the RRC CONNECTED states, the network can use old measurement data together with new measurement data for a faster verification procedure. That is, the old measurement data, such as taken in the previous connection or while being in the RRC IDLE or RRC INACTIVE state, is still considered valid.

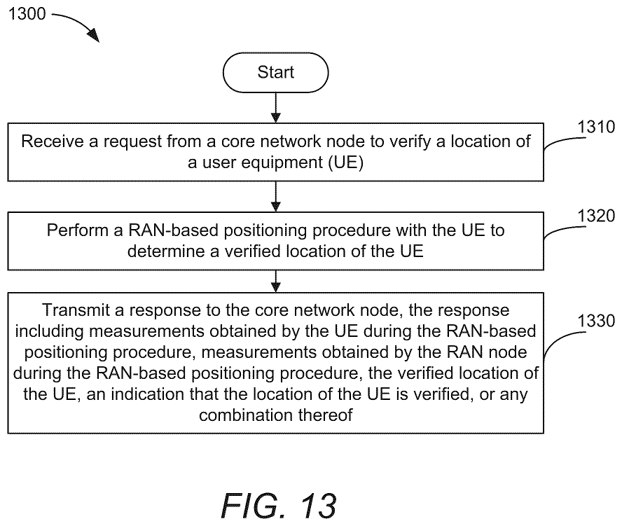

FIG. 13 illustrates an example method 1300 of location verification, according to aspects of the disclosure. In an aspect, method 1300 may be performed by a RAN node (e.g., any of the NG-RAN nodes described herein).

At 1310, the RAN node receives a request from a core network node to verify a location of a UE, as at stage 4 of FIG. 8 or stage 1 of FIG. 11. In an aspect, operation 1310 may be performed by the one or more WWAN transceivers 350, satellite signal receiver 370, the one or more network transceivers 380, the one or more processors 384, memory 386, and/or positioning component 388, any or all of which may be considered means for performing this operation.

At 1320, the RAN node performs a RAN-based positioning procedure with the UE to determine a verified location of the UE, as at stage 5 of FIG. 8 or stage 2 of FIG. 11. In an aspect, operation 1320 may be performed by the one or more WWAN transceivers 350, satellite signal receiver 370, the one or more network transceivers 380, the one or more processors 384, memory 386, and/or positioning component 388, any or all of which may be considered means for performing this operation.

At 1330, the RAN node transmits a response to the core network node, as at stage 6 of FIG. 8 or stage 3 of FIG. 11, the response including: measurements obtained by the UE during the RAN-based positioning procedure, measurements obtained by the RAN node during the RAN-based positioning procedure, the verified location of the UE, an indication that the location of the UE is verified, or any combination thereof. In an aspect, operation 1330 may be performed by the one or more WWAN transceivers 350, satellite signal receiver 370, the one or more network transceivers 380, the one or more processors 384, memory 386, and/or positioning component 388, any or all of which may be considered means for performing this operation.

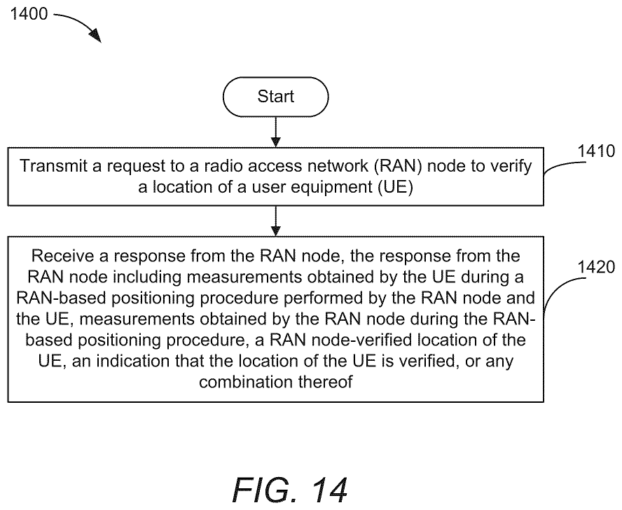

FIG. 14 illustrates an example method 1400 of location verification, according to aspects of the disclosure. In an aspect, method 1400 may be performed by a core network node (e.g., an AMF).

At 1410, the core network node transmits a request to a RAN node to verify a location of a UE, as at stage 4 of FIG. 8 or stage 1 of FIG. 11. In an aspect, operation 1410 may be performed by the one or more network transceivers 390, the one or more processors 394, memory 396, and/or positioning component 398, any or all of which may be considered means for performing this operation.

At 1420, the core network node receives a response from the RAN node, as at stage 6 of FIG. 8 or stage 3 of FIG. 11, the response from the RAN node including measurements obtained by the UE during a RAN-based positioning procedure performed by the RAN node and the UE, measurements obtained by the RAN node during the RAN-based positioning procedure, a RAN node-verified location of the UE, an indication that the location of the UE is verified, or any combination thereof. In an aspect, operation 1420 may be performed by the one or more network transceivers 390, the one or more processors 394, memory 396, and/or positioning component 398, any or all of which may be considered means for performing this operation.

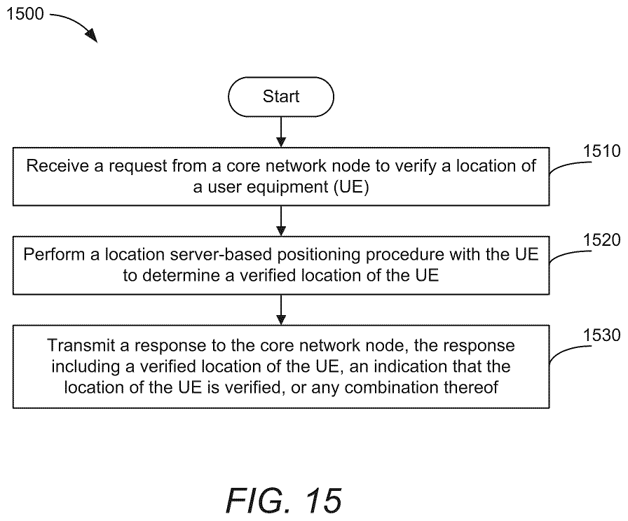

FIG. 15 illustrates an example method 1500 of location verification, according to aspects of the disclosure. In an aspect, method 1500 may be performed by a location server (e.g., an LMF).

At 1510, the location server receives a request from a core network node to verify a location of a UE, as at stage 7 of FIG. 8 or stage 1 of FIG. 9. In an aspect, operation 1510 may be performed by the one or more network transceivers 390, the one or more processors 394, memory 396, and/or positioning component 398, any or all of which may be considered means for performing this operation.

At 1520, the location server performs a location server-based positioning procedure with the UE to determine a verified location of the UE, as at stage 8 of FIG. 8 or stage 3 of FIG. 9. In an aspect, operation 1520 may be performed by the one or more network transceivers 390, the one or more processors 394, memory 396, and/or positioning component 398, any or all of which may be considered means for performing this operation.

At 1530, the location server transmits a response to the core network node, as at stage 9 of FIG. 8 or stage 4 of FIG. 9, the response including a verified location of the UE, an indication that the location of the UE is verified, or any combination thereof. In an aspect, operation 1530 may be performed by the one or more network transceivers 390, the one or more processors 394, memory 396, and/or positioning component 398, any or all of which may be considered means for performing this operation.

As will be appreciated, a technical advantage of the methods 1300 to 1500 is enabling network verification of a UE's location.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of location verification performed by a radio access network (RAN) node, comprising: receiving a request from a core network node to verify a location of a user equipment (UE); performing a RAN-based positioning procedure with the UE to determine a verified location of the UE; and transmitting a response to the core network node, the response including: measurements obtained by the UE during the RAN-based positioning procedure, measurements obtained by the RAN node during the RAN-based positioning procedure, the verified location of the UE, an indication that the location of the UE is verified, or any combination thereof.

Clause 2. The method of clause 1, wherein the response further includes a type of the RAN-based positioning procedure.

Clause 3. The method of any of clauses 1 to 2, wherein: the response includes the indication that the location of the UE is verified, the indication that the location of the UE is verified comprises a Boolean value, and the response further includes a confidence value indicating a confidence in the verified location of the UE.

Clause 4. The method of any of clauses 1 to 3, further comprising: transmitting a capability message to the core network node, the capability message indicating that the RAN node is capable of verifying the location of the UE.

Clause 5. The method of clause 4, wherein the RAN node has a steerable spare beam.

Clause 6. The method of any of clauses 1 to 5, wherein the RAN node is or is located on a space vehicle.

Clause 7. The method of any of clauses 1 to 6, wherein the core network node is: an access and mobility management function (AMF), or a location management function (LMF).

Clause 8. A method of location verification performed by a core network node, comprising: transmitting a request to a radio access network (RAN) node to verify a location of a user equipment (UE); and receiving a response from the RAN node, the response from the RAN node including measurements obtained by the UE during a RAN-based positioning procedure performed by the RAN node and the UE, measurements obtained by the RAN node during the RAN-based positioning procedure, a RAN node-verified location of the UE, an indication that the location of the UE is verified, or any combination thereof.

Clause 9. The method of clause 8, further comprising: receiving a request from a second core network node to verify the location of the UE; and transmitting a response to the second core network node, the response to the second core network node including the measurements obtained by the UE during the RAN-based positioning procedure, the measurements obtained by the RAN node during the RAN-based positioning procedure, the RAN node-verified location of the UE, the indication that the location of the UE is verified, or any combination thereof.

Clause 10. The method of clause 9, wherein the second core network node is a location management function (LMF).

Clause 11. The method of any of clauses 8 to 10, further comprising: transmitting a request to a location server to verify the location of the UE; and receiving a response from the location server, the response from the location server including a location server-verified location of the UE, an indication that the location of the UE is verified, or any combination thereof.

Clause 12. The method of clause 11, further comprising: determining whether the location of the UE is verified based on the response from the RAN node, the response from the location server, or both.

Clause 13. The method of any of clauses 11 to 12, wherein: the response from the location server includes the location server-verified location of the UE, the response from the location server further includes a type of a location server-based positioning procedure performed between the location server and the UE to determine the location server-verified location of the UE, and the location server-verified location of the UE is determined to be verified based on the type of the location server-based positioning procedure.

Clause 14. The method of any of clauses 11 to 13, wherein: the response from the location server includes the indication that the location of the UE is verified, the indication that the location of the UE is verified comprises a Boolean value, and the response further includes a confidence value indicating a confidence in the location server-verified location of the UE.

Clause 15. The method of any of clauses 8 to 14, wherein the response from the RAN node further includes a type of the RAN-based positioning procedure.

Clause 16. The method of any of clauses 8 to 15, wherein: the response from the RAN node includes the indication that the location of the UE is verified, the indication that the location of the UE is verified comprises a Boolean value, and the response further includes a confidence value indicating a confidence in the RAN node-verified location of the UE.

Clause 17. The method of any of clauses 8 to 16, further comprising: receiving a capability message from the RAN node, the capability message indicating that the RAN node is capable of verifying the location of the UE.

Clause 18. The method of any of clauses 8 to 17, further comprising: triggering a validity timer for the RAN node-verified location of the UE; and triggering a subsequent UE location verification procedure based on one or more triggering events.

Clause 19. The method of clause 18, wherein the one or more triggering events comprise: expiration of the validity timer, a UE tracking area update, a UE registration area update, a change in UE location above a threshold, a change in country of UE's location, or any combination thereof.

Clause 20. The method of any of clauses 18 to 19, wherein the subsequent UE location verification procedure is not triggered based on the location of the UE changing during radio resource control (RRC) state transitions less than a threshold.

Clause 21. The method of any of clauses 8 to 20, wherein the core network node is an access and mobility management function (AMF).

Clause 22. A method of location verification performed by a location server, comprising: receiving a request from a core network node to verify a location of a user equipment (UE); performing a location server-based positioning procedure with the UE to determine a verified location of the UE; and transmitting a response to the core network node, the response including a verified location of the UE, an indication that the location of the UE is verified, or any combination thereof.

Clause 23. The method of clause 22, wherein: the response includes the verified location of the UE, and the response further includes a type of the location server-based positioning procedure.

Clause 24. The method of any of clauses 22 to 23, wherein: the response includes the indication that the location of the UE is verified, the indication that the location of the UE is verified comprises a Boolean value, and the response further includes a confidence value indicating a confidence in the verified location of the UE.

Clause 25. The method of any of clauses 22 to 24, wherein the request includes: an identifier of the UE, an indication of a region in which the UE is expected to be located, one or more accuracy parameters, a timer within which the location server is expected to provide the response, or any combination thereof.

Clause 26. The method of any of clauses 22 to 25, wherein the response includes: the response includes the indication that the location of the UE is verified, a type of the location server-based positioning procedure, a quality of service (QoS), an error cause, an amount of time taken to determine the verified location of the UE, a confidence value indicating a confidence in the verified location of the UE, or any combination thereof.

Clause 27. The method of clause 26, wherein the error cause comprises a value indicating: denied positioning, unsupported by UE, positioning failed, or request timeout.

Clause 28. A radio access network (RAN) node, comprising: a memory; at least one transceiver; and at least one processor communicatively coupled to the memory and the at least one transceiver, the at least one processor configured to: receive, via the at least one transceiver, a request from a core network node to verify a location of a user equipment (UE); perform a RAN-based positioning procedure with the UE to determine a verified location of the UE; and transmit, via the at least one transceiver, a response to the core network node, the response including: measurements obtained by the UE during the RAN-based positioning procedure, measurements obtained by the RAN node during the RAN-based positioning procedure, the verified location of the UE, an indication that the location of the UE is verified, or any combination thereof.

Clause 29. The RAN node of clause 28, wherein the response further includes a type of the RAN-based positioning procedure.

Clause 30. The RAN node of any of clauses 28 to 29, wherein: the response includes the indication that the location of the UE is verified, the indication that the location of the UE is verified comprises a Boolean value, and the response further includes a confidence value indicating a confidence in the verified location of the UE.

Clause 31. The RAN node of any of clauses 28 to 30, wherein the at least one processor is further configured to: transmit, via the at least one transceiver, a capability message to the core network node, the capability message indicating that the RAN node is capable of verifying the location of the UE.

Clause 32. The RAN node of clause 31, wherein the RAN node has a steerable spare beam.

Clause 33. The RAN node of any of clauses 28 to 32, wherein the RAN node is or is located on a space vehicle.

Clause 34. The RAN node of any of clauses 28 to 33, wherein the core network node is: an access and mobility management function (AMF), or a location management function (LMF).

Clause 35. A core network node, comprising: a memory; at least one transceiver; and at least one processor communicatively coupled to the memory and the at least one transceiver, the at least one processor configured to: transmit, via the at least one transceiver, a request to a radio access network (RAN) node to verify a location of a user equipment (UE); and receive, via the at least one transceiver, a response from the RAN node, the response from the RAN node including measurements obtained by the UE during a RAN-based positioning procedure performed by the RAN node and the UE, measurements obtained by the RAN node during the RAN-based positioning procedure, a RAN node-verified location of the UE, an indication that the location of the UE is verified, or any combination thereof.

Clause 36. The core network node of clause 35, wherein the at least one processor is further configured to: receive, via the at least one transceiver, a request from a second core network node to verify the location of the UE; and transmit, via the at least one transceiver, a response to the second core network node, the response to the second core network node including the measurements obtained by the UE during the RAN-based positioning procedure, the measurements obtained by the RAN node during the RAN-based positioning procedure, the RAN node-verified location of the UE, the indication that the location of the UE is verified, or any combination thereof.

Clause 37. The core network node of clause 36, wherein the second core network node is a location management function (LMF).

Clause 38. The core network node of any of clauses 35 to 37, wherein the at least one processor is further configured to: transmit, via the at least one transceiver, a request to a location server to verify the location of the UE; and receive, via the at least one transceiver, a response from the location server, the response from the location server including a location server-verified location of the UE, an indication that the location of the UE is verified, or any combination thereof.

Clause 39. The core network node of clause 38, wherein the at least one processor is further configured to: determine whether the location of the UE is verified based on the response from the RAN node, the response from the location server, or both.

Clause 40. The core network node of any of clauses 38 to 39, wherein: the response from the location server includes the location server-verified location of the UE, the response from the location server further includes a type of a location server-based positioning procedure performed between the location server and the UE to determine the location server-verified location of the UE, and the location server-verified location of the UE is determined to be verified based on the type of the location server-based positioning procedure.

Clause 41. The core network node of any of clauses 38 to 40, wherein: the response from the location server includes the indication that the location of the UE is verified, the indication that the location of the UE is verified comprises a Boolean value, and the response further includes a confidence value indicating a confidence in the location server-verified location of the UE.

Clause 42. The core network node of any of clauses 35 to 41, wherein the response from the RAN node further includes a type of the RAN-based positioning procedure.

Clause 43. The core network node of any of clauses 35 to 42, wherein: the response from the RAN node includes the indication that the location of the UE is verified, the indication that the location of the UE is verified comprises a Boolean value, and the response further includes a confidence value indicating a confidence in the RAN node-verified location of the UE.

Clause 44. The core network node of any of clauses 35 to 43, wherein the at least one processor is further configured to: receive, via the at least one transceiver, a capability message from the RAN node, the capability message indicating that the RAN node is capable of verifying the location of the UE.

Clause 45. The core network node of any of clauses 35 to 44, wherein the at least one processor is further configured to: trigger a validity timer for the RAN node-verified location of the UE; and trigger a subsequent UE location verification procedure based on one or more triggering events.

Clause 46. The core network node of clause 45, wherein the one or more triggering events comprise: expiration of the validity timer, a UE tracking area update, a UE registration area update, a change in UE location above a threshold, a change in country of UE's location, or any combination thereof.

Clause 47. The core network node of any of clauses 45 to 46, wherein the subsequent UE location verification procedure is not triggered based on the location of the UE changing during radio resource control (RRC) state transitions less than a threshold.

Clause 48. The core network node of any of clauses 35 to 47, wherein the core network node is an access and mobility management function (AMF).

Clause 49. A location server, comprising: a memory; at least one transceiver; and at least one processor communicatively coupled to the memory and the at least one transceiver, the at least one processor configured to: receive, via the at least one transceiver, a request from a core network node to verify a location of a user equipment (UE); perform a location server-based positioning procedure with the UE to determine a verified location of the UE; and transmit, via the at least one transceiver, a response to the core network node, the response including a verified location of the UE, an indication that the location of the UE is verified, or any combination thereof.

Clause 50. The location server of clause 49, wherein: the response includes the verified location of the UE, and the response further includes a type of the location server-based positioning procedure.

Clause 51. The location server of any of clauses 49 to 50, wherein: the response includes the indication that the location of the UE is verified, the indication that the location of the UE is verified comprises a Boolean value, and the response further includes a confidence value indicating a confidence in the verified location of the UE.

Clause 52. The location server of any of clauses 49 to 51, wherein the request includes: an identifier of the UE, an indication of a region in which the UE is expected to be located, one or more accuracy parameters, a timer within which the location server is expected to provide the response, or any combination thereof.

Clause 53. The location server of any of clauses 49 to 52, wherein the response includes: the response includes the indication that the location of the UE is verified, a type of the location server-based positioning procedure, a quality of service (QoS), an error cause, an amount of time taken to determine the verified location of the UE, a confidence value indicating a confidence in the verified location of the UE, or any combination thereof.

Clause 54. The location server of clause 53, wherein the error cause comprises a value indicating: denied positioning, unsupported by UE, positioning failed, or request timeout.

Clause 55. A radio access network (RAN) node, comprising: means for receiving a request from a core network node to verify a location of a user equipment (UE); means for performing a RAN-based positioning procedure with the UE to determine a verified location of the UE; and means for transmitting a response to the core network node, the response including: measurements obtained by the UE during the RAN-based positioning procedure, measurements obtained by the RAN node during the RAN-based positioning procedure, the verified location of the UE, an indication that the location of the UE is verified, or any combination thereof.

Clause 56. The RAN node of clause 55, wherein the response further includes a type of the RAN-based positioning procedure.

Clause 57. The RAN node of any of clauses 55 to 56, wherein: the response includes the indication that the location of the UE is verified, the indication that the location of the UE is verified comprises a Boolean value, and the response further includes a confidence value indicating a confidence in the verified location of the UE.

Clause 58. The RAN node of any of clauses 55 to 57, further comprising: means for transmitting a capability message to the core network node, the capability message indicating that the RAN node is capable of verifying the location of the UE.

Clause 59. The RAN node of clause 58, wherein the RAN node has a steerable spare beam.

Clause 60. The RAN node of any of clauses 55 to 59, wherein the RAN node is or is located on a space vehicle.

Clause 61. The RAN node of any of clauses 55 to 60, wherein the core network node is: an access and mobility management function (AMF), or a location management function (LMF).

Clause 62. A core network node, comprising: means for transmitting a request to a radio access network (RAN) node to verify a location of a user equipment (UE); and means for receiving a response from the RAN node, the response from the RAN node including measurements obtained by the UE during a RAN-based positioning procedure performed by the RAN node and the UE, measurements obtained by the RAN node during the RAN-based positioning procedure, a RAN node-verified location of the UE, an indication that the location of the UE is verified, or any combination thereof.

Clause 63. The core network node of clause 62, further comprising: means for receiving a request from a second core network node to verify the location of the UE; and means for transmitting a response to the second core network node, the response to the second core network node including the measurements obtained by the UE during the RAN-based positioning procedure, the measurements obtained by the RAN node during the RAN-based positioning procedure, the RAN node-verified location of the UE, the indication that the location of the UE is verified, or any combination thereof.

Clause 64. The core network node of clause 63, wherein the second core network node is a location management function (LMF).

Clause 65. The core network node of any of clauses 62 to 64, further comprising: means for transmitting a request to a location server to verify the location of the UE; and means for receiving a response from the location server, the response from the location server including a location server-verified location of the UE, an indication that the location of the UE is verified, or any combination thereof.

Clause 66. The core network node of clause 65, further comprising: means for determining whether the location of the UE is verified based on the response from the RAN node, the response from the location server, or both.

Clause 67. The core network node of any of clauses 65 to 66, wherein: the response from the location server includes the location server-verified location of the UE, the response from the location server further includes a type of a location server-based positioning procedure performed between the location server and the UE to determine the location server-verified location of the UE, and the location server-verified location of the UE is determined to be verified based on the type of the location server-based positioning procedure.

Clause 68. The core network node of any of clauses 65 to 67, wherein: the response from the location server includes the indication that the location of the UE is verified, the indication that the location of the UE is verified comprises a Boolean value, and the response further includes a confidence value indicating a confidence in the location server-verified location of the UE.

Clause 69. The core network node of any of clauses 62 to 68, wherein the response from the RAN node further includes a type of the RAN-based positioning procedure.

Clause 70. The core network node of any of clauses 62 to 69, wherein: the response from the RAN node includes the indication that the location of the UE is verified, the indication that the location of the UE is verified comprises a Boolean value, and the response further includes a confidence value indicating a confidence in the RAN node-verified location of the UE.

Clause 71. The core network node of any of clauses 62 to 70, further comprising: means for receiving a capability message from the RAN node, the capability message indicating that the RAN node is capable of verifying the location of the UE.

Clause 72. The core network node of any of clauses 62 to 71, further comprising: means for triggering a validity timer for the RAN node-verified location of the UE; and means for triggering a subsequent UE location verification procedure based on one or more triggering events.

Clause 73. The core network node of clause 72, wherein the one or more triggering events comprise: expiration of the validity timer, a UE tracking area update, a UE registration area update, a change in UE location above a threshold, a change in country of UE's location, or any combination thereof.

Clause 74. The core network node of any of clauses 72 to 73, wherein the subsequent UE location verification procedure is not triggered based on the location of the UE changing during radio resource control (RRC) state transitions less than a threshold.

Clause 75. The core network node of any of clauses 62 to 74, wherein the core network node is an access and mobility management function (AMF).

Clause 76. A location server, comprising: means for receiving a request from a core network node to verify a location of a user equipment (UE); means for performing a location server-based positioning procedure with the UE to determine a verified location of the UE; and means for transmitting a response to the core network node, the response including a verified location of the UE, an indication that the location of the UE is verified, or any combination thereof.

Clause 77. The location server of clause 76, wherein: the response includes the verified location of the UE, and the response further includes a type of the location server-based positioning procedure.

Clause 78. The location server of any of clauses 76 to 77, wherein: the response includes the indication that the location of the UE is verified, the indication that the location of the UE is verified comprises a Boolean value, and the response further includes a confidence value indicating a confidence in the verified location of the UE.

Clause 79. The location server of any of clauses 76 to 78, wherein the request includes: an identifier of the UE, an indication of a region in which the UE is expected to be located, one or more accuracy parameters, a timer within which the location server is expected to provide the response, or any combination thereof.

Clause 80. The location server of any of clauses 76 to 79, wherein the response includes: the response includes the indication that the location of the UE is verified, a type of the location server-based positioning procedure, a quality of service (QoS), an error cause, an amount of time taken to determine the verified location of the UE, a confidence value indicating a confidence in the verified location of the UE, or any combination thereof.

Clause 81. The location server of clause 80, wherein the error cause comprises a value indicating: denied positioning, unsupported by UE, positioning failed, or request timeout.

Clause 82. A non-transitory computer-readable medium storing computer-executable instructions that, when executed by a radio access network (RAN) node, cause the RAN to: receive a request from a core network node to verify a location of a user equipment (UE); perform a RAN-based positioning procedure with the UE to determine a verified location of the UE; and transmit a response to the core network node, the response including: measurements obtained by the UE during the RAN-based positioning procedure, measurements obtained by the RAN node during the RAN-based positioning procedure, the verified location of the UE, an indication that the location of the UE is verified, or any combination thereof.

Clause 83. The non-transitory computer-readable medium of clause 82, wherein the response further includes a type of the RAN-based positioning procedure.

Clause 84. The non-transitory computer-readable medium of any of clauses 82 to 83, wherein: the response includes the indication that the location of the UE is verified, the indication that the location of the UE is verified comprises a Boolean value, and the response further includes a confidence value indicating a confidence in the verified location of the UE.

Clause 85. The non-transitory computer-readable medium of any of clauses 82 to 84, further comprising computer-executable instructions that, when executed by the RAN node, cause the RAN node to: transmit a capability message to the core network node, the capability message indicating that the RAN node is capable of verifying the location of the UE.

Clause 86. The non-transitory computer-readable medium of clause 85, wherein the RAN node has a steerable spare beam.

Clause 87. The non-transitory computer-readable medium of any of clauses 82 to 86, wherein the RAN node is or is located on a space vehicle.

Clause 88. The non-transitory computer-readable medium of any of clauses 82 to 87, wherein the core network node is: an access and mobility management function (AMF), or a location management function (LMF).

Clause 89. A non-transitory computer-readable medium storing computer-executable instructions that, when executed by a core network node, cause the core network node to: transmit a request to a radio access network (RAN) node to verify a location of a user equipment (UE); and receive a response from the RAN node, the response from the RAN node including measurements obtained by the UE during a RAN-based positioning procedure performed by the RAN node and the UE, measurements obtained by the RAN node during the RAN-based positioning procedure, a RAN node-verified location of the UE, an indication that the location of the UE is verified, or any combination thereof.

Clause 90. The non-transitory computer-readable medium of clause 89, further comprising computer-executable instructions that, when executed by the core network node, cause the core network node to: receive a request from a second core network node to verify the location of the UE; and transmit a response to the second core network node, the response to the second core network node including the measurements obtained by the UE during the RAN-based positioning procedure, the measurements obtained by the RAN node during the RAN-based positioning procedure, the RAN node-verified location of the UE, the indication that the location of the UE is verified, or any combination thereof.

Clause 91. The non-transitory computer-readable medium of clause 90, wherein the second core network node is a location management function (LMF).

Clause 92. The non-transitory computer-readable medium of any of clauses 89 to 91, further comprising computer-executable instructions that, when executed by the core network node, cause the core network node to: transmit a request to a location server to verify the location of the UE; and receive a response from the location server, the response from the location server including a location server-verified location of the UE, an indication that the location of the UE is verified, or any combination thereof.

Clause 93. The non-transitory computer-readable medium of clause 92, further comprising computer-executable instructions that, when executed by the core network node, cause the core network node to: determine whether the location of the UE is verified based on the response from the RAN node, the response from the location server, or both.

Clause 94. The non-transitory computer-readable medium of any of clauses 92 to 93, wherein: the response from the location server includes the location server-verified location of the UE, the response from the location server further includes a type of a location server-based positioning procedure performed between the location server and the UE to determine the location server-verified location of the UE, and the location server-verified location of the UE is determined to be verified based on the type of the location server-based positioning procedure.

Clause 95. The non-transitory computer-readable medium of any of clauses 92 to 94, wherein: the response from the location server includes the indication that the location of the UE is verified, the indication that the location of the UE is verified comprises a Boolean value, and the response further includes a confidence value indicating a confidence in the location server-verified location of the UE.

Clause 96. The non-transitory computer-readable medium of any of clauses 89 to 95, wherein the response from the RAN node further includes a type of the RAN-based positioning procedure.

Clause 97. The non-transitory computer-readable medium of any of clauses 89 to 96, wherein: the response from the RAN node includes the indication that the location of the UE is verified, the indication that the location of the UE is verified comprises a Boolean value, and the response further includes a confidence value indicating a confidence in the RAN node-verified location of the UE.

Clause 98. The non-transitory computer-readable medium of any of clauses 89 to 97, further comprising computer-executable instructions that, when executed by the core network node, cause the core network node to: receive a capability message from the RAN node, the capability message indicating that the RAN node is capable of verifying the location of the UE.

Clause 99. The non-transitory computer-readable medium of any of clauses 89 to 98, further comprising computer-executable instructions that, when executed by the core network node, cause the core network node to: trigger a validity timer for the RAN node-verified location of the UE; and trigger a subsequent UE location verification procedure based on one or more triggering events.

Clause 100. The non-transitory computer-readable medium of clause 99, wherein the one or more triggering events comprise: expiration of the validity timer, a UE tracking area update, a UE registration area update, a change in UE location above a threshold, a change in country of UE's location, or any combination thereof.

Clause 101. The non-transitory computer-readable medium of any of clauses 99 to 100, wherein the subsequent UE location verification procedure is not triggered based on the location of the UE changing during radio resource control (RRC) state transitions less than a threshold.

Clause 102. The non-transitory computer-readable medium of any of clauses 89 to 101, wherein the core network node is an access and mobility management function (AMF).

Clause 103. A non-transitory computer-readable medium storing computer-executable instructions that, when executed by a location server, cause the location server to: receive a request from a core network node to verify a location of a user equipment (UE); perform a location server-based positioning procedure with the UE to determine a verified location of the UE; and transmit a response to the core network node, the response including a verified location of the UE, an indication that the location of the UE is verified, or any combination thereof.

Clause 104. The non-transitory computer-readable medium of clause 103, wherein: the response includes the verified location of the UE, and the response further includes a type of the location server-based positioning procedure.

Clause 105. The non-transitory computer-readable medium of any of clauses 103 to 104, wherein: the response includes the indication that the location of the UE is verified, the indication that the location of the UE is verified comprises a Boolean value, and the response further includes a confidence value indicating a confidence in the verified location of the UE.

Clause 106. The non-transitory computer-readable medium of any of clauses 103 to 105, wherein the request includes: an identifier of the UE, an indication of a region in which the UE is expected to be located, one or more accuracy parameters, a timer within which the location server is expected to provide the response, or any combination thereof.

Clause 107. The non-transitory computer-readable medium of any of clauses 103 to 106, wherein the response includes: the response includes the indication that the location of the UE is verified, a type of the location server-based positioning procedure, a quality of service (QoS), an error cause, an amount of time taken to determine the verified location of the UE, a confidence value indicating a confidence in the verified location of the UE, or any combination thereof.

Clause 108. The non-transitory computer-readable medium of clause 107, wherein the error cause comprises a value indicating: denied positioning, unsupported by UE, positioning failed, or request timeout.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method of location verification performed by a radio access network (RAN) node, comprising:
receiving a request from a core network node to verify a location of a user equipment (UE);
performing a RAN-based positioning procedure with the UE to determine a verified location of the UE; and
transmitting a response to the core network node, the response including: measurements obtained by the UE during the RAN-based positioning procedure, measurements obtained by the RAN node during the RAN-based positioning procedure, the verified location of the UE, an indication that the location of the UE is verified, or any combination thereof.

2. The method of claim 1, wherein the response further includes a type of the RAN-based positioning procedure.

3. The method of claim 1, wherein:
the response includes the indication that the location of the UE is verified,
the indication that the location of the UE is verified comprises a Boolean value, and
the response further includes a confidence value indicating a confidence in the verified location of the UE.

4. The method of claim 1, further comprising:
transmitting a capability message to the core network node, the capability message indicating that the RAN node is capable of verifying the location of the UE.

5. The method of claim 4, wherein:
the RAN node has a steerable spare beam.

6. The method of claim 1, wherein the RAN node is or is located on a space vehicle.

7. The method of claim 1, wherein the core network node is:
an access and mobility management function (AMF), or
a location management function (LMF).

8. A method of location verification performed by a core network node, comprising:
transmitting a request to a radio access network (RAN) node to verify a location of a user equipment (UE); and
receiving a response from the RAN node, the response from the RAN node including measurements obtained by the UE during a RAN-based positioning procedure performed by the RAN node and the UE, measurements obtained by the RAN node during the RAN-based positioning procedure, a RAN node-verified location of the UE, an indication that the location of the UE is verified, or any combination thereof.

9. The method of claim 8, further comprising:
receiving a request from a second core network node to verify the location of the UE; and
transmitting a response to the second core network node, the response to the second core network node including the measurements obtained by the UE during the RAN-based positioning procedure, the measurements obtained by the RAN node during the RAN-based positioning procedure, the RAN node-verified location of the UE, the indication that the location of the UE is verified, or any combination thereof.

10. The method of claim 9, wherein the second core network node is a location management function (LMF).

11. The method of claim 8, further comprising:
transmitting a request to a location server to verify the location of the UE; and
receiving a response from the location server, the response from the location server including a location server-verified location of the UE, an indication that the location of the UE is verified, or any combination thereof.

12. The method of claim 11, further comprising:
determining whether the location of the UE is verified based on the response from the RAN node, the response from the location server, or both.

13. The method of claim 11, wherein:
the response from the location server includes the location server-verified location of the UE,
the response from the location server further includes a type of a location server-based positioning procedure performed between the location server and the UE to determine the location server-verified location of the UE, and
the location server-verified location of the UE is determined to be verified based on the type of the location server-based positioning procedure.

14. The method of claim 11, wherein:
the response from the location server includes the indication that the location of the UE is verified,
the indication that the location of the UE is verified comprises a Boolean value, and
the response further includes a confidence value indicating a confidence in the location server-verified location of the UE.

15. The method of claim 8, wherein the response from the RAN node further includes a type of the RAN-based positioning procedure.

16. The method of claim 8, wherein:
the response from the RAN node includes the indication that the location of the UE is verified,
the indication that the location of the UE is verified comprises a Boolean value, and
the response further includes a confidence value indicating a confidence in the RAN node-verified location of the UE.

17. The method of claim 8, further comprising:
receiving a capability message from the RAN node, the capability message indicating that the RAN node is capable of verifying the location of the UE.

18. The method of claim 8, further comprising:
triggering a validity timer for the RAN node-verified location of the UE; and
triggering a subsequent UE location verification procedure based on one or more triggering events.

19. The method of claim 18, wherein the one or more triggering events comprise:
expiration of the validity timer,
a UE tracking area update,
a UE registration area update,
a change in UE location above a threshold,
a change in country of UE's location, or
any combination thereof.

20. The method of claim 18, wherein the subsequent UE location verification procedure is not triggered based on the location of the UE changing during radio resource control (RRC) state transitions less than a threshold.

21. The method of claim 8, wherein the core network node is an access and mobility management function (AMF).

22. A method of location verification performed by a location server, comprising:
receiving a request from a core network node to verify a location of a user equipment (UE);
performing a location server-based positioning procedure with the UE to determine a verified location of the UE; and
transmitting a response to the core network node, the response including a verified location of the UE, an indication that the location of the UE is verified, or any combination thereof.

23. The method of claim 22, wherein:
the response includes the verified location of the UE, and
the response further includes a type of the location server-based positioning procedure.

24. The method of claim 22, wherein:
the response includes the indication that the location of the UE is verified,
the indication that the location of the UE is verified comprises a Boolean value, and
the response further includes a confidence value indicating a confidence in the verified location of the UE.

25. The method of claim 22, wherein the request includes:
an identifier of the UE,
an indication of a region in which the UE is expected to be located,
one or more accuracy parameters,
a timer within which the location server is expected to provide the response, or
any combination thereof.

26. The method of claim 22, wherein the response includes:
the response includes the indication that the location of the UE is verified,
a type of the location server-based positioning procedure,
a quality of service (QoS),
an error cause,
an amount of time taken to determine the verified location of the UE,
a confidence value indicating a confidence in the verified location of the UE, or
any combination thereof.

27. The method of claim 26, wherein the error cause comprises a value indicating:
denied positioning,
unsupported by UE,
positioning failed, or
request timeout.

28. A radio access network (RAN) node, comprising:
a memory;
at least one transceiver; and
at least one processor communicatively coupled to the memory and the at least one transceiver, the at least one processor configured to:
receive, via the at least one transceiver, a request from a core network node to verify a location of a user equipment (UE);
perform a RAN-based positioning procedure with the UE to determine a verified location of the UE; and
transmit, via the at least one transceiver, a response to the core network node, the response including: measurements obtained by the UE during the RAN-based positioning procedure, measurements obtained by the RAN node during the RAN-based positioning procedure, the verified location of the UE, an indication that the location of the UE is verified, or any combination thereof.

29. The RAN node of claim 28, wherein the response further includes a type of the RAN-based positioning procedure.

30. The RAN node of claim 28, wherein:
the response includes the indication that the location of the UE is verified,
the indication that the location of the UE is verified comprises a Boolean value, and
the response further includes a confidence value indicating a confidence in the verified location of the UE.
